(19) United States
(12) Patent Application Publication
(10) Pub. No.: US 2003/0118193 A1
(43) Pub. Date: Jun. 26, 2003

(54) Method and system for digitally controlling a speaker

(76) Inventors: Lawrence A. Leske, San Carlos, CA (US); David L. Medin, Los Altos, CA (US)

Correspondence Address: SAWYER LAW GROUP LLP, P.O. Box 51418, Palo Alto, CA, 94303, US

(21) Appl. No.: 10/029,552

(22) Filed: Dec. 21, 2001

(51) Int. Cl. H04R 29/00

(52) U.S. Cl. 381/59; 381/58

(57) ABSTRACT

A method and system for generating sound using a speaker having a transducer is disclosed. In a first aspect, the method and system comprise conditioning an input signal; and analyzing the conditioned signal in accordance with at least one transducer model. The method and system further includes providing a drive signal based upon the analysis and modulating a drive signal provided to the transducer. In a second aspect, a method and system for determining the positional BL factor of a transducer during sound transduction is disclosed. The method and system comprises continually at short time intervals measuring the change of the current to the transducer; measuring the back EMF of the transducer; and calculating the present positional BL factor from the change in EMF versus change in current. The new positional BL factor is then utilized directly in the transducer model.

### FIELD OF THE INVENTION

The present invention relates generally to audio systems and more particularly to a system and method for controlling a speaker in such a system.

### BACKGROUND OF THE INVENTION

Speakers are used in a variety of applications including audio, radio receivers, stereo equipment, speakerphone systems, and a variety of other environments. It is important to control the speakers so that the sound provided by the speaker is of high quality/is as close as possible to the original sound source. FIG. 1 is a block diagram illustrating a typical speaker system 10. As is seen, an electrical signal which may be digital or analog is provided to a signal analysis shaping system 12. In a conventional system, this signal analysis system is based on a speaker enclosure and preference model that will be described in detail hereinafter. Thereafter the signal is provided to a power switch to transducer 14 that activates the speaker assembly 15. In a conventional speaker, a transducer is typically a voice coil. However, many types of devices could be utilized as a transducer in a speaker. As has been before mentioned, a conventional signal processing system does provide for standard audio amplification. To describe this processing analysis shaping system of the system 12, refer now to the following discussion in conjunction with the accompanying flowchart.

FIG. 2 is a flow chart of a conventional signal processing system 12 for standard audio amplification. The input signal, which may be in either analog or digital format, is provided to the amplifier assembly via step 18. The signal is adjusted to correct for speaker enclosure distortions, via step 20. This comprises correctional adjustments for frequency response due to resonances, anti-resonances and phase errors created in multi-driver systems within speaker enclosures due to alignment errors of sound emitters, such as the transducer.

Conventional approaches may also include correctional adjustments of frequency response due to resonances, anti-resonances and phase errors due to room and environmental distortions, via step 22. For example, adjustments may involve depeaking of resonances to try to flatten the frequency response.

Conventionally the input signal is also adjusted for user preferences, in terms of frequency amplitude adjustment, etc., via step 24. Finally, the input signal may be adjusted for each driver of the speaker system, sending only the high frequency signal to the tweeter, the low frequencies to the woofer or subwoofers, etc., via step 26. Following the completion of all correctional adjustments, the signal is sent to the output amplifier.

The problem with this type of adjustment is that there are frequency dependent errors that are provided as well as phase dependent errors. This is due to the analog components within the system. In a stereo system, for example, the apparent position that a sound is heard due to both amplitude and phasing may be off, and what is called “presence” is lost. For example, if the amplitude information is available, there is a sense of where things are at/located, but it doesn't sound accurate. The reason it doesn't sound accurate is that the phase angles from the various sounds do not line up correctly.

In another example, in the most critical stage of a system in which there are three speakers, i.e., a woofer, a midrange and a tweeter, due to the way that the frequencies are separated, the phase alignment is lost because in utilizing analog circuitry it is almost impossible to provide frequency separation and maintain phase. It is possible to use a very high-end digital system to correct these problems; however, these systems are very expensive and as will be described hereinafter, they also do not correct for the speaker deficiencies.

FIG. 3 is an illustration of a typical conventional speaker system 100. The framework 110 holds the speaker cone 111. The speaker cone 111 is acted upon by the transducer driver 113 that acts as a motor, causing the cone to vibrate and create pressure variations in the air. The transducer driver 113, which consists of a coil of wire, is wound around a tube or form 112. The transducer 113 is charged with an electrical current, which acts upon the magnetic field developed by the magnet and iron assembly 116 and by the gap 150 in which the transducer rides. The magnetic field, driven by the external current, acts against the magnetic field in the gap 150 and causes the transducer 113 to move forward or backward. The damper springs 114 hold the transducer 113 in place in a center position, and then pull it back when there is no energy on the transducer 113, acting as dampers.

There are three fundamental problems with the conventional speaker. First, it should be understood that speakers are rated at some resistance, such as 4 ohms, 8 ohms, or 16 ohms, etc. The assumption essentially is that an amplifier takes the signal that is analog or digital, and provides a high current and a high power output to drive a speaker at some constant resistance, i.e., 4 ohms or 8 ohms. The problem is that the speaker is actually a moving coil inductor, and as a moving coil inductor it has a high number of nonlinearities that will absolutely not allow it to act as a simple constant resistor at all frequencies and amplitudes over time. The primary nonlinearity is the nonlinearity of the magnetic field that acts on the moving coil.

Normally there is a force equation associated with the moving coil acted on by that field. If the magnetic field were absolutely constant for the transducer, the voice force equation would be linear. So the force equation is F=BLI, where F is the force, B is the magnetic intensity, L is the width of the gap at the transducer, and I is the current through the transducer. The problem as can be seen is that the transducer itself is much wider than the magnetic field gap in a typical speaker. In the gap, the field is constant. But the problem is that as the transducer moves beyond the gap, where the magnetic intensity is not constant.

Accordingly, this problem could be solved by making the gap wide and the transducer very narrow. However, this would significantly increase the cost of the speaker. So what is desired is a way of using existing speakers in which this problem is not present.

Accordingly, the problem is that as the transducer moves, it is moving into fringe areas where there is some magnetic field at the edge of the gap, but the magnetic field rapidly goes away. So accordingly it is moving back and forth through nonlinear regions. As the transducer moves, part of it will be in the region but a good portion of the transducer will be out into less and less magnetic field. The direction of the movement is irrelevant; it is just movement outside of the gap. This movement outside of the gap creates nonlinearities, because the BL factor effectively decreases.

The current does not change, so the force decreases. Accordingly, if the force changes drastically, the sound will change and that is indeed what happens with most speakers. Even if presented through today's standard amplifiers with absolutely perfect voltage to drive these speakers in a linear fashion, the BL factor change will ensure that there will not be a linear sound out.

There are two or three other factors involved that affect the performance of the speaker. One is that even if the transducer (i.e., voice coil) is an inductor, that inductance is not constant either. Because the magnetic field has an effect on the inductions of the transducer, it changes as it moves in and out of the field also. In addition, the dampers that are attached to the transducer increase the force the further the transducer moves, so this also has a nonlinear effect. The resistance of the transducer changes over time depending on the power that is induced. So as the speaker/or the transducer heats up, the resistance changes. This has an effect on the circuitry associated with the transducer and the current through that circuitry.

Finally, the output may be affected by changes in the voltage supplied to it by a power supply. Often at higher powers the voltage drops due to the added load, and consequently distorts the output sound. Another closely related issue is noise induced into the power supply by other circuits. This noise if uncompensated could affect the quality of the sound output.

Another closely related issue is the prevention of the destruction of the transducer by high power levels that can raise the temperature of the transducer high enough to melt the coil or distort the form the wire is wrapped on. Either of which could stop the transducer from operating.

Accordingly, there are several factors above described that significantly affect the ability to provide an accurate sound in a conventional speaker. Some of the issues can be addressed by improving the circuitry through digital means; however, those can be expensive and are not available to the normal consumer. In addition, even with the digital circuitry to handle the signal shaping, the speaker itself has significant nonlinearities that can never be addressed adequately by shaping the input signal to the speaker. Accordingly, what is desired is a system that allows for the control of the speaker in a manner that allows for it to provide the optimum linear sound. One that also corrects problems induced by the power supply, and protects the transducer from destruction due to the power being at a high level for too long a period. The system should be easy to implement, cost effective, and easily adaptable to existing speaker systems. The present invention addresses such a need.

### SUMMARY OF THE INVENTION

A method and system for generating sound using a speaker having a transducer is disclosed. In a first aspect, the method and system comprise conditioning an input signal; and analyzing the conditioned signal in accordance with at least one transducer model. The method and system further includes providing a drive signal based upon the analysis and modulating a drive signal provided to the transducer.

In a second aspect, a method and system for determining the positional BL factor of a transducer during sound transduction is disclosed. The method and system comprises continually at short time intervals measuring the change of the current to the transducer; measuring the back EMF of the transducer; and calculating the present positional BL factor from the change in EMF versus change in current. The new positional BL factor is then utilized directly in the transducer model.

In a third aspect, a method and system for measuring the current instantaneous BL factor of a transducer is disclosed. The method and system comprises utilizing the instantaneous BL factor as a means to verify the present position of the transducer. Such position being used dynamically to adjust the transducer driver model for positional nonlinearities.

In a fourth aspect, a method and system for generating sound using a speaker having a transducer is disclosed. The method and system comprises determining the positional BL factor during sound transduction through continual measurements, and digitally modulating a drive signal based on a plurality of transducer models and the positional BL factor during sound transduction of the transducer.

In a fifth aspect, a method and system for improving a sound generation device is disclosed. The method and system comprises measuring a power supply voltage of the device and adjusting a drive signal to the device to compensate for changes in the power supply voltage.

In a sixth aspect, a method and system for protecting a speaker comprises continually determining a drive provided to a transducer of the speaker and adjusting the drive signal based upon a safe power model of the transducer and the drive power.

### BRIEF DESCRIPTION OF THE DRAWINGS

FIG. 1 is a block diagram illustrating a typical speaker system.

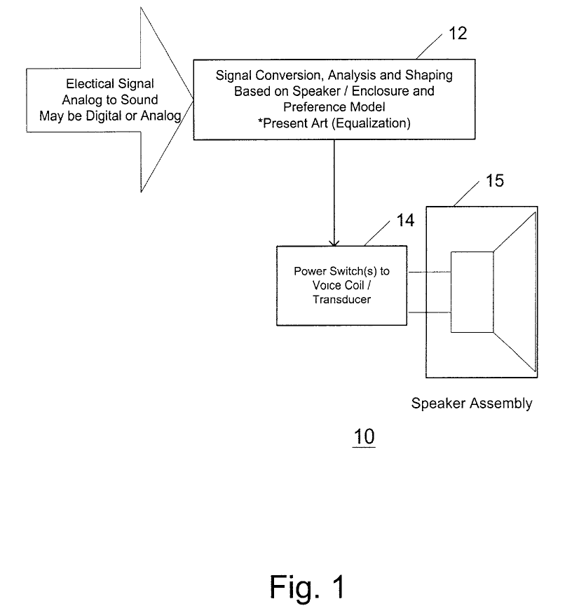

FIG. 2 is a flow chart of a conventional signal processing system for standard audio amplification.

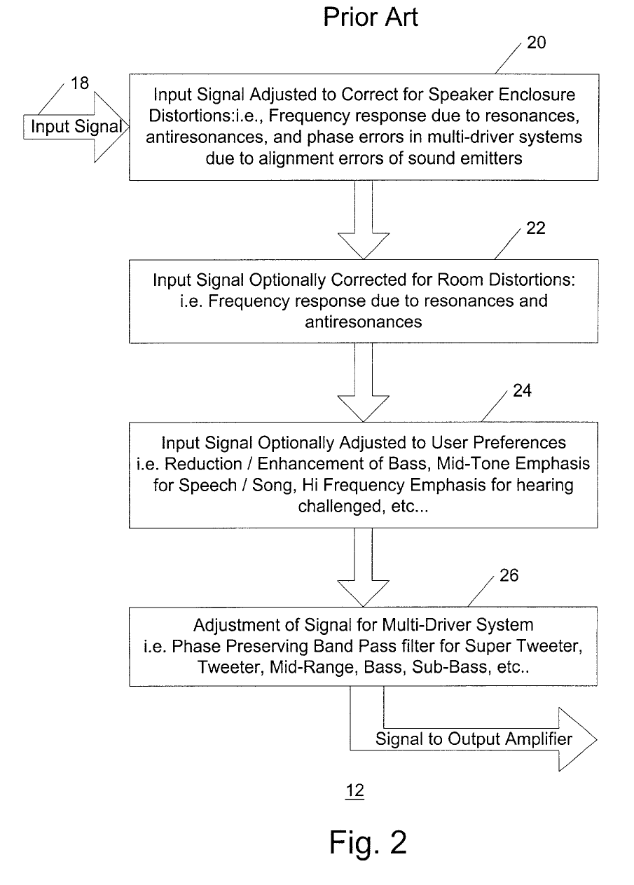

FIG. 3 is an illustration of a typical conventional speaker system.

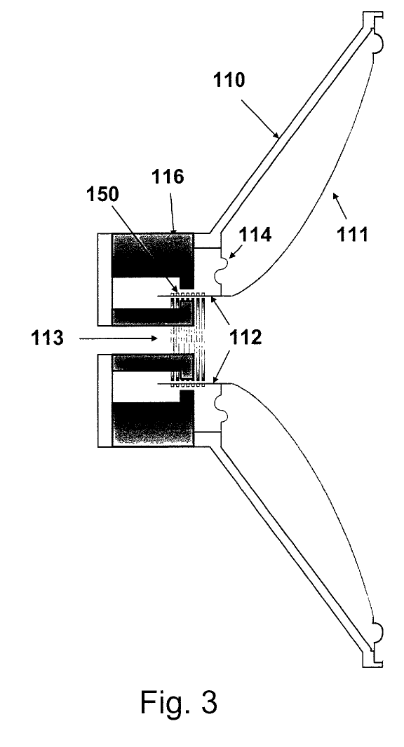

FIG. 4 illustrates a system for controlling a speaker in accordance with the present invention.

FIG. 5 illustrates the shaping system, output modulator and transducer of the speaker in more detail.

FIG. 5a is a flow chart illustrating the generation of voice models for the output analyzer.

FIG. 6 is a flow chart illustrating the operation of the output signal analyzer in more detail.

FIG. 7 is a flow chart illustrating the operation of the output signal modulator.

### DETAILED DESCRIPTION

The present invention relates to generally to audio systems and more particularly to a system and method for controlling a speaker in such a system. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

Accordingly, a system and method in accordance with the present invention controls and corrects for the nonlinearities in the speaker, as well as the nonlinearities created by the amplifier system. The control and correction of the speaker is accomplished by utilizing conventional techniques to condition the signal. Thereafter, the conditioned signal is analyzed and presented to the transducer of the speaker to generate a model of the transducer that includes both the positional nonlinearities and the electrophysical model of the transducer. In so doing, the position of the transducer can be identified. Accordingly, utilizing a system and method in accordance with the present invention, the transducer linearities can be identified and the transducer can be adjusted to correct for those linearities.

In a preferred embodiment, a transducer for a speaker is driven with a current (or voltage) switch modulated by a digital signal created using a simple differential model of the speaker: where d (BL)/dx represents the value of the BL factor with regard to the position of the moving coil, which may either be modeled as an equation or as a table of values per position so that for each change in the incoming signal to be transduced into sound, the change in relative sound pressure level is calculated for each new value of the time sampled input signal according to: Input Signal/dt(ime)=d(Sound Pressure)/dt(ime) which, normalized to the particular speaker parameters, such as the area of the, is in proportion to:

(d(Force(voice coil))/dt)=((d(BL)/dx)*dI/dt)).

The objective of the invention is to linearize this equation so that the change in force is in linear proportion to the input signal principally by controlling the change in current to the transducer to counter the nonlinearities of the BL factor and associated circuitry. This is accomplished by utilizing an electrophysical model of the loudspeaker driver, modified by either an inverse function of the non-linear BL with regard to the relative position of the moving coil, or by a means to directly measure the BL factor during operation. In order to ensure that the model remains faithful to actual transducer movements, two independent means of approximating position are employed. One uses a simple electrophysical model of the moving coil's motion, while the second monitors the change in back EMF versus the change in drive current in order to estimate the current BL factor. This is then compared to the drive coil's BL versus position curve to provide a confirming estimate of position. Due to the inherent accumulation of errors in the electromechanical model's integrators, its current position is reset to zero whenever the input signal is at or near zero for sufficient time for the coil to come to rest. Alternately, its position is compared to that predicted by the delta EMF to delta current model, and adjusted if the discrepancy is too large.

In a second aspect, the above model is modified by adjusting the switching current to account for changes in power supply voltage. A means of sensing this voltage is included. The model may either use a simple linear model to adjust the current, or may utilize a resistive capacitive model of the power supply in order to further reduce the error in the expected output current pulse. This will significantly reduce audio distortion when the output is near the SPL limit of the driver. It will also reduce the effects of other noise induced in the power supply, such as those from digital switched circuits and their harmonics.

In a third aspect of this invention, a power limit over time model is developed for the driver, in order to prevent the destruction of the driver. The current power over time is compared to the model, and if limits are expected to be exceeded, the output power signal is reduced to enable safe operation. This allows higher output sound power signal transients to be handled safely, providing a transducer with more apparent power at a lower cost. It also reduces the cost of protecting the most expensive and generally unrepairable piece of the loudspeaker, the drive coil.

Advantages of the invention may include one or more of the following. The system achieves higher fidelity sound reproduction meeting performance criteria such as more linear and extended frequency response, reduced distortion, diminished phase errors, higher dynamic range, and transiently higher sound output. High fidelity sound is reproduced at high power efficiency through precisely controlled pulses of current, or gating of a voltage source. These pulses are generated by a processor controlled circuit that electrophysically models the driver as a function of its BL*I force developed in order to precisely move the voice coil, in order to effect the movement of the loudspeaker cone, baffle, or other sound moving media, which transduces motion into sound. Models of the transducer are used to minimize the phase distortions produced by the transducer itself, and the transducer's impact on the power source while producing a high power efficiency of conversion to audio sound.

A system and method in accordance with the present invention could be implemented utilizing software, hardware or any combination thereof. For example, an application specific integrated circuit (ASIC) such as a digital signal processor (DSP) could be utilized. A combination of a software program that is in a computer readable medium, such as a floppy disk, DVD, CD-ROM or the like, could also be utilized to implement a system and method in accordance with the present invention. For a more particular description of the features of the present invention, refer now to the following discussion in conjunction with the accompanying figures.

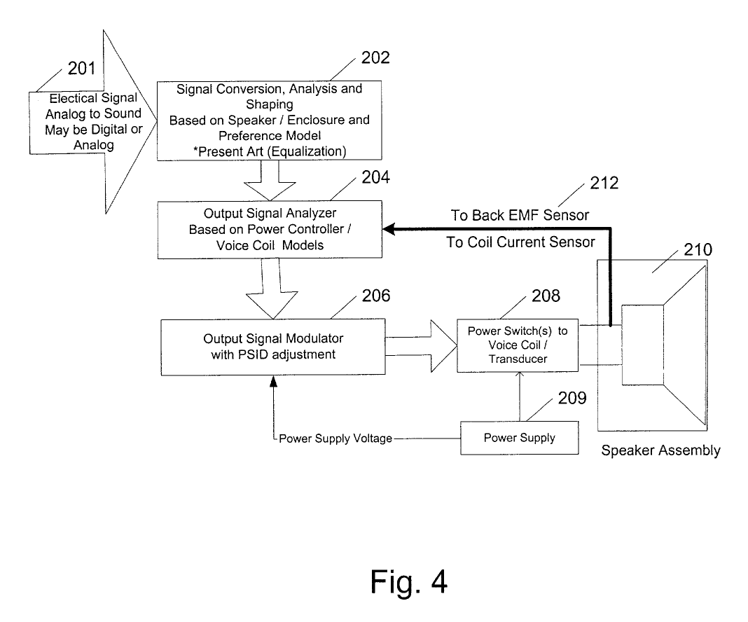

FIG. 4 illustrates a system for controlling a speaker in accordance with the present invention. The system 200 includes a conventional speaker assembly 210 and a conventional signal conversion analysis and shaping system 202. The system 202 utilizes conventional techniques to condition the input signal. The system 202 also includes an output signal analyzer 204 that receives the conditioned signal from the shaping system 202, and provides a conditioned signal to an output signal modulator 206. Since the primary objective of the output signal modulator is to provide current to the transducer according to the BLI force equation, any modulator, whether analog or digital, which effects the appropriate current may be used. The output signal modulator 206 controls a power switch 208 that in turn is coupled to a transducer of the speaker 210. A power supply 204 associated with the power switch provides power to the speakers and is also fed back to the output signal modulator 206. Signals representing a back EMF and transducer current sensor 212 are fed back to the output signal analyzer to allow for further correction for nonlinearities in the speaker. Each of the elements of FIG. 4 is described in more detail below.

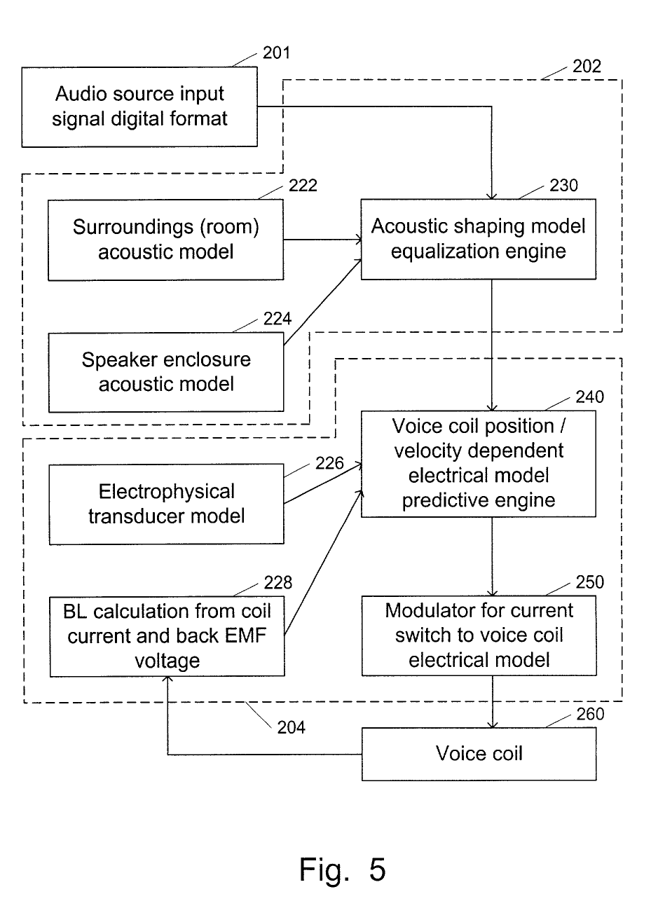

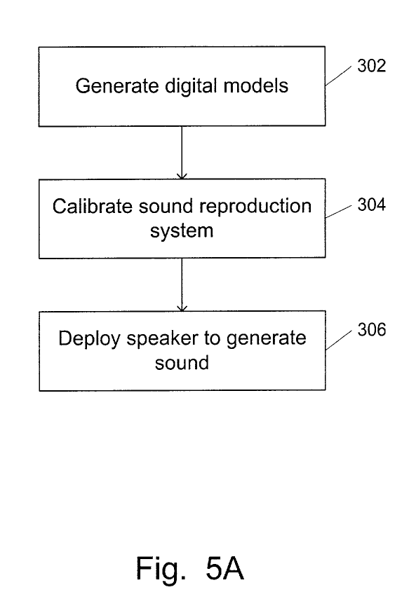

FIG. 5 illustrates the shaping system 202, output modulator 204 and the transducer of the speaker 210 in more detail. As is seen, an audio source input signal 201 that is in digital format is provided to the shaping system 202 via an acoustic shaping engine 230. The shaping engine 230 also receives inputs from the surroundings of the acoustical model 222 and a speaker enclosure acoustic model 224. These elements of the models 222 and 224 are conventional in nature. The output from the acoustic shaping engine 202, which is a conditioned input signal, is then provided to the output signal analyzer 204. The predictive engine 240 receives inputs from the transducer models and the BL calculation from transducer current and back EMF model 228. The transducer models are provided by generating data concerning the operation of the voice under different loads to provide an electrophysical model of the transducer such that the position of the transducer can be predicted at all times. One piece of the data are models generated by actually testing the transducer over a range of signals.

FIG. 5a is a flow chart illustrating the generation of voice models for the output analyzer. First, digital models are generated, via step 302. Thereafter, the sound reproduction system is calibrated based upon the models, via step 304. Finally, the speaker is deployed to generate sound, via step 306. As mentioned, the output of this is to the modulator for current to switch to transducer electrical model, and that is used to control the transducer within the speaker.

A second piece of data is a BL calculation for the transducer current and back EMF that is fed back from the transducer itself. In so doing, the state of the current and voltage can be dynamically measured and the BL function can be adjusted in response thereto.

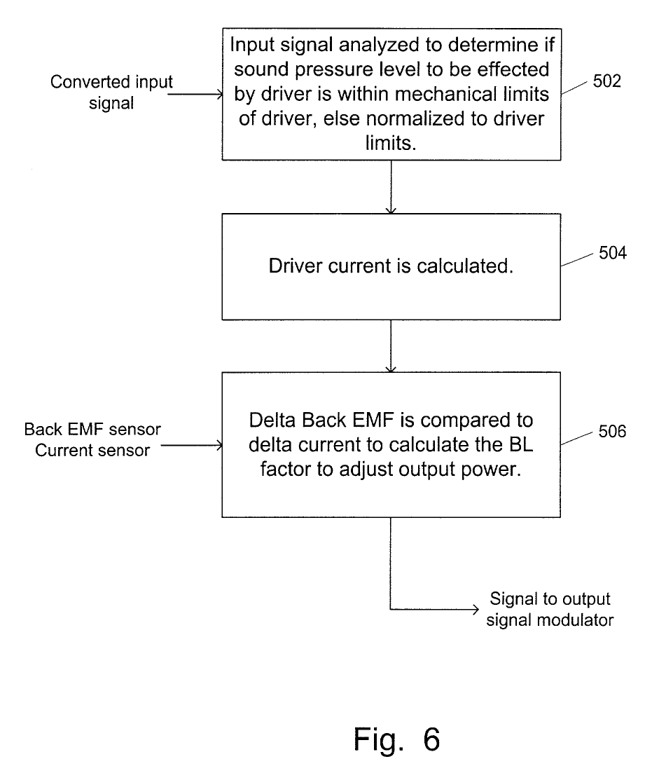

FIG. 6 is a flow chart illustrating the operation of the output signal analyzer 202 in more detail. First, the conditioned input signal is provided to the input signal analyzer to determine if sound pressure level to be affected by the driver is within mechanical limits of the driver, or otherwise is normalized to driver limits, via step 502. Next, the transducer, driver current is calculated I=force/BL (driver nominal), via step 504. Then, the Delta Back EMF is compared to the Delta Current, via step 506 in order to calculate the current BL factor dynamically or through an equation of the BL factor with regard to position. Optionally, the BL factor can be used to index into BL vs position table, to verify or adjust position. The driver force (current) may be further adjusted due to present position, momentum, cone tension, air pressure, and other disturbing factors such as humidity, temperature, power supply variations. Then the drive force signal is provided to the output signal modulator, via step 508. Once the output signal modulator receives the signal, one other correction can be made to significantly improve the performance thereof, that is, a power signal correction.

Safe Power Supply

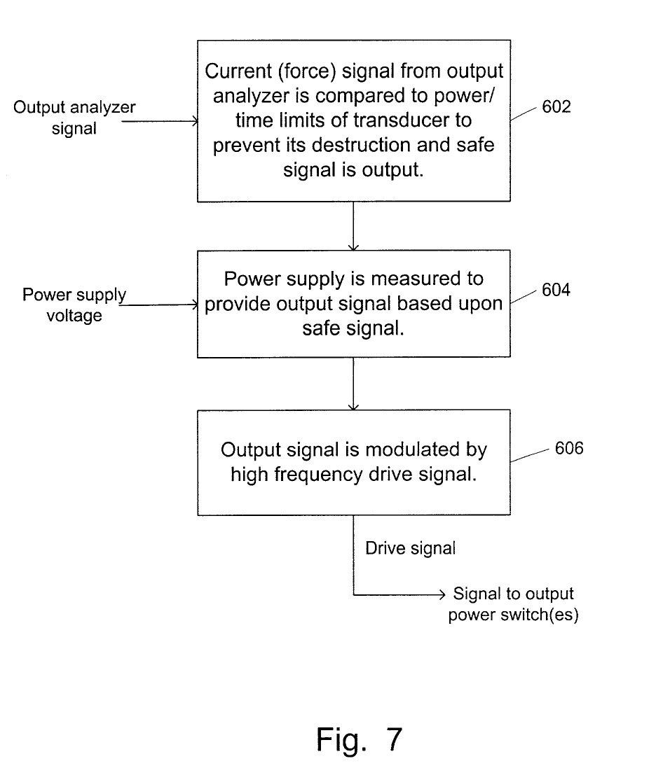

FIG. 7 is a flow chart illustrating the operation of the output signal modulator 206. First, a drive signal is compared to power/time limits of the transducer to prevent its destruction by providing a safe signal, via step 602. Accordingly, in this aspect of the present invention, the development of a safe power versus time model of the driver in order to prevent the destruction of the driver, usually from high temperature breakdowns, is utilized to provide greater transient sound output at a lower cost. A safe power versus timetable or safe power equation is utilized to protect the speaker by allowing a greater range of transient sounds at a lower cost.. The table or equation is checked for every signal input over the appropriate time interval (usually at least 10 s of milliseconds to seconds) to determine if the current power over time would exceed operational limits. If it would, then the output power is reduced until such time as the higher power is safe for transient operation.

Power Supply Induced Distortion System

To minimize power supply induced distortion (PSID), an output signal based upon the safe signal is used. This distortion may either be due to nominal power supply fluctuations due to design constraints, or may be due to other load induced fluctuations, such as from other digital or analog circuits utilizing this supply. In this embodiment, the output signal=safe signal×Vnominal/Vmeasured. In the alternative a power supply droop model could be used to determine additional adjustment if needed.

The output signal is also modulated by the drive signal to reduce power supply induced distortion (PSID). First, for every output cycle or group of cycles, the current value of the power supply voltage is measured, and the pulse width modulation is adjusted, via step 606. The pulse is preferably adjusted to the desired shape by changing the amplitude or duration. Thus, the pulse could be widened, heightened, narrowed or lowered dependent upon the value of the power supply voltage. If an analog audio signal is used (no pulse width), the amplitude of the signal can be modified to achieve the same result. In this aspect an internal model of the power supply, such as a simple RC time constant of the power supply output filter and the pulse width/is optionally maintained/is modified based on the required output power. This aspect, in addition to saving costs on the power supply, also reduces power supply induced distortion (PSID) which is often highly detrimental to sound quality.

Finally, the drive signal is then directed to appropriate drive circuit and the signal is provided to the output power switch, via step 606.

Accordingly, a system and method in accordance with the present invention controls and corrects for the nonlinearities in the speaker, as well as the nonlinearities created by the amplifier system. The control and correction of the speaker is accomplished by utilizing conventional techniques to condition the signal. Thereafter, the conditioned signal is analyzed and presented to the transducer of the speaker to generate a model of the transducer that includes both the positional nonlinearities and the electrophysical model of the transducer. In so doing, the position of the transducer can be identified. Accordingly, utilizing a system and method in accordance with the present invention, the transducer linearities can be identified and the transducer can be adjusted to correct for those linearities.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A method for determining the positional BL factor of a transducer during sound transduction comprising the steps of:
(a) changing the current to the transducer;
(b) determining the current through the transducer;
(c) measuring the back EMF of the transducer; and
(d) calculating the positional BL factor from the change in EMF versus change in current.

2. The method of claim 1, further comprising applying the drive signal to a switch to drive the transducer to generate sound, wherein the drive signal is one of a digital and analog.

3. A method for measuring the back EMF of a transducer comprising the steps of:
(a) providing a digitally modulated signal; and
(b) measuring the voltage across the transducer during the off time of the digitally modulated signal.

4. The method of claim 3, further comprising applying the drive signal to a switch to drive the transducer to generate sound, wherein the drive signal is digital or analog.

5. A method for generating sound using a speaker having a transducer, comprising the steps of:
(a) determining the positional BL factor during sound transduction through continual measurements; and
(b) digitally modulating a drive signal based on a plurality of transducer models and the positional BL factor during sound transduction of the transducer.

6. The method of claim 5, further comprising applying the drive signal to a switch to drive the transducer to generate sound, wherein the drive signal is digital or analog.

7. A method for generating sound using a speaker having a transducer, comprising the steps of:
(a) generating an electrophysical model of the transducer,
(b) digitally modulating a drive signal based on the continually determined position of the transducer in the electrophysical model,
(c) determining a positional BL factor during sound transduction through continual measurements;
(d) calculating the position of the transducer based upon the BL factor;
(e) updating the position of the transducer in the electrophysical model; and
(f) repeating steps b-e.

8. The method of claim 7, wherein an electrophysical model of the transducer is generated by driving the transducer with a known set of signals, determining the position of the transducer, and measuring one or more of: the back EMF, the power supply voltage, and the transducer current.

9. The method of claim 7 further comprising applying the drive signal to a switch to drive the transducer to generate sound, wherein the drive signal is digital or analog.

10. A method for improving a sound generation device comprising the steps of:
(a) measuring a power supply voltage of the device; and
(b) adjusting a drive signal to the device to compensate for changes in the power supply voltage.

11. The method of claim 10 wherein the drive signal is adjusted by adjusting the shape of the drive signal.

12. The method of claim 11 wherein the pulse shape is adjusted by adjusting the amplitude and/or width of the pulse.

13. The method of claim 10 wherein the drive signal is adjusted by adjusting the amplitude of the drive signal.

14. The method of claim 10 which includes the step of generating a model of the power supply.

15. The method of claim 10 which includes the step of:
(e) modulating the output signal to minimize power supply induced distortion (PSID), wherein the output signal is provided to a switch to drive the transducer to generate sound, wherein the drive signal is digital or analog.

16. A method for protecting a speaker having a transducer comprising the steps of:
(a) continually determining a drive power provided to the transducer and
(b) adjusting the drive signal based upon a safe power model of the transducer and the drive power.

17. The method of claim 16 wherein the drive power is integrated over time.

18. The method of claim 16 which includes the step of measuring a power supply voltage to provide an output signal based upon the safe power model.

19. A system for determining the positional BL factor of a transducer during sound transduction comprising:
means for changing the current to the transducer;
means fordetermining the current through the transducer;
means for measuring the back EMF of the transducer; and
means for calculating the positional BL factor from the change in EMF versus change in current.

20. The system of claim 19, further comprising applying the drive signal to a switch to drive the transducer to generate sound, wherein the drive signal is one of a digital and analog.

21. A system for measuring the back EMF of a transducer comprising:
means for providing a digitally modulated signal; and
means for measuring the voltage across the transducer during the off time of the digitally modulated signal.

22. The system of claim 21, further comprising means for applying the drive signal to a switch to drive the transducer to generate sound, wherein the drive signal is digital or analog.

23. A system for generating sound using a speaker having a transducer, comprising:
means for determining the positional BL factor during sound transduction through continual measurements; and
means for digitally modulating a drive signal based on a plurality of transducer models and the positional BL factor during sound transduction of the transducer.

24. The system of claim 23, further comprising means for applying the drive signal to a switch to drive the transducer to generate sound, wherein the drive signal is digital or analog.

25. A system for generating sound using a speaker having a transducer, comprising:
means for generating an electrophysical model of the transducer,
means for digitally modulating a drive signal based on the continually determined position of the transducer in the electrophysical model,
means for determining a positional BL factor during sound transduction through continual measurements;
means for calculating the position of the transducer based upon the BL factor; and
means for updating the position of the transducer in the electrophysical model.

26. The system of claim 25, wherein an electrophysical model of the transducer is generated by driving the transducer with a known set of signals, determining the position of the transducer, and measuring one or more of: the back EMF, the power supply voltage, and the transducer current.

27. The system of claim 25 further comprising means for applying the drive signal to a switch to drive the transducer to generate sound, wherein the drive signal is digital or analog.

28. A system for improving a sound generation device comprising the steps of:
means for measuring a power supply voltage of the device; and
means for adjusting a drive signal to the device to compensate for changes in the power supply voltage.

29. The system of claim 28 wherein the drive signal is adjusted by adjusting the shape of the drive signal.

30. The system of claim 29 wherein the pulse shape is adjusted by adjusting the amplitude and/or width of the pulse.

31. The system of claim 28 wherein the drive signal is adjusted by adjusting the amplitude of the drive signal.

32. The system of claim 28 which includes the means for generating a model of the power supply.

33. The system of claim 28 which includes:
means for modulating the output signal to minimize power supply induced distortion (PSID), wherein the output signal is provided to a switch to drive the transducer to generate sound, wherein the drive signal is digital or analog.

34. A system for protecting a speaker having a transducer comprising:
means for continually determining a drive power provided to the transducer and
means for adjusting the drive signal based upon a safe power model of the transducer and the drive power.

35. The system of claim 34 wherein the drive power is integrated over time.

36. The system of claim 34 which includes the step of measuring a power supply voltage to provide an output signal based upon the safe power model.

37. A computer readable medium containing program instructions for determining the positional BL factor of a transducer during sound transduction comprising the steps of:
(a) changing the current to the transducer;
(b) determining the current through the transducer;
(c) measuring the back EMF of the transducer; and
(d) calculating the positional BL factor from the change in EMF versus change in current.

38. The computer readable medium of claim 37, further comprising applying the drive signal to a switch to drive the transducer to generate sound, wherein the drive signal is one of a digital and analog.

39. A computer readable medium containing program instructionsfor measuring the back EMF of a transducer comprising the steps of:
(a) providing a digitally modulated signal; and
(b) measuring the voltage across the transducer during the off time of the digitally modulated signal.

40. The computer readable medium of claim 39, further comprising applying the drive signal to a switch to drive the transducer to generate sound, wherein the drive signal is digital or analog.

41. A computer readable medium containing program instructions for generating sound using a speaker having a transducer, comprising the steps of:
(a) determining the positional BL factor during sound transduction through continual measurements; and
(b) digitally modulating a drive signal based on a plurality of transducer models and the positional BL factor during sound transduction of the transducer.

42. The computer readable medium of claim 41, further comprising applying the drive signal to a switch to drive the transducer to generate sound, wherein the drive signal is digital or analog.

43. A computer readable medium containing program instructions for generating sound using a speaker having a transducer, comprising the steps of:
(a) generating an electrophysical model of the transducer,
(b) digitally modulating a drive signal based on the continually determined position of the transducer in the electrophysical model,
(c) determining a positional BL factor during sound transduction through continual measurements;
(d) calculating the position of the transducer based upon the BL factor;
(e) updating the position of the transducer in the electrophysical model; and
(f) repeating steps b-e.

44. The computer readable medium of claim 43, wherein an electrophysical model of the transducer is generated by driving the transducer with a known set of signals, determining the position of the transducer, and measuring one or more of: the back EMF, the power supply voltage, and the transducer current.

45. The computer readable medium of claim 43 further comprising applying the drive signal to a switch to drive the transducer to generate sound, wherein the drive signal is digital or analog.

46. A computer readable medium containing program instructions for improving a sound generation device comprising the steps of:
(a) measuring a power supply voltage of the device; and
(b) adjusting a drive signal to the device to compensate for changes in the power supply voltage.

47. The computer readable medium of claim 46 wherein the drive signal is adjusted by adjusting the shape of the drive signal.

48. The computer readable medium of claim 47 wherein the pulse shape is adjusted by adjusting the amplitude and/or width of the pulse.

49. The computer readable medium of claim 46 wherein the drive signal is adjusted by adjusting the amplitude of the drive signal.

50. The computer readable medium of claim 46 which includes the step of generating a model of the power supply.

51. The computer readable medium of claim 46 which includes the step of:
(e) modulating the output signal to minimize power supply induced distortion (PSID), wherein the output signal is provided to a switch to drive the transducer to generate sound, wherein the drive signal is digital or analog.

52. A computer readable medium containing program instructions for protecting a speaker having a transducer comprising the steps of:
(a) continually determining a drive power provided to the transducer and
(b) adjusting the drive signal based upon a safe power model of the transducer and the drive power.

53. The computer readable medium of claim 52 wherein the drive power is integrated over time.

54. The computer readable medium of claim 52 which includes the step of measuring a power supply voltage to provide an output signal based upon the safe power model.
